(19) United States
(12) Patent Application Publication
(10) Pub. No.: US 2017/0197355 A1
(43) Pub. Date: Jul. 13, 2017

(54) Embossing Tool

(71) Applicant: Hueck Rheinische GmbH, Viersen (DE)

(72) Inventors: Wolfgang Stoffel, Kempen (DE); Martin Marxen, Viersen (DE)

(21) Appl. No.: 15/469,492

(22) Filed: Mar. 25, 2017

Related U.S. Application Data
(63) Continuation-in-part of application No. 14/377,175, filed on Aug. 7, 2014.

(30) Foreign Application Priority Data
May 4, 2012 (DE) 202012004375.7

(51) Int. Cl. B29C 59/04; B29C 33/38; B23P 15/24; B44B 5/02; B44F 9/02; B29C 59/02; B29C 33/42

(52) U.S. Cl. CPC B29C 59/04; B29C 59/022; B29C 33/3842; B29C 33/424; B44B 5/026; B44F 9/02; B23P 15/246; B29C 2033/426

(57) ABSTRACT

An embossing tool comprised of a pressing plate or endless belt that includes a structured surface, a first gloss level over the full area of the structured surface, and further, different gloss levels in several selected areas of the structured surface. The gloss levels are created by mechanical post-treatment and/or chemical post-treatment. A method for producing the embossing tool is also involved. The structured surface is provided with a first gloss level over the full area and receives further, different gloss levels in several selected areas in further work steps. The gloss levels are created via a mechanical post-treatment and/or chemical post-treatment.

### CROSS REFERENCE TO RELATED APPLICATIONS

This application is a continuation-in-part of U.S. Ser. No. 14/377,175, which was the U.S. national stage of International Application No. PCT/DE2013/000145 filed on Mar. 15, 2013, and claims the benefit thereof. The international application claims the benefit under 35 USC 119 of German Application No. DE202012004375.7 filed on May 4, 2012; all applications are incorporated by reference herein in their entirety.

### BACKGROUND

The invention relates to a composite board with at least one structured surface side, in particular a surface with a wood pore, wherein raised and recessed areas are formed.

Composite boards are required in diverse forms, for instance to manufacture floor coverings in the form of panels, but likewise to manufacture furniture, wall coverings, door frames and door leaves. Furthermore, with regard to the use of composite boards that are custom-cut to corresponding sizes, there is a need for these plates to have structured surfaces in accordance with customer desires. This could involve a wood pore or graphic structuring, for example. If naturally grown wood material is not going to be used, the possibility exists to use a composite board that has appropriate decoration and structuring, at least on one of the two sides.

The composite boards are preferably manufactured from a fibrous material as the substrate layer in the core area and covered with a defined sequence of paper or non-woven layers; the individual layers are impregnated with an amino resin, for instance melanin formaldehyde resin, and hardened in a press under the influence of heat. When pressed with the application of heat and pressure, the structure hardens to form an amino resin layer and bonds the individual layers to the substrate layer, so a very stable composite board arises with the correspondingly structured surface.

Furthermore, the possibility exists, depending on the intended use, for the top layer to be enriched with abrasion-resistant particles in the form of an overlay paper. The abrasion resistance of the composite boards that are manufactured, for instance in the area of floors, will be significantly increased because of this. It is customary here to add particles made of corundum, melanin that has already set or glass to one of the uppermost layers, in order to protect the layers underneath that, especially the decorative layer, from wear and tear.

The procedure for manufacturing the wooden composite boards involves laying the resin films onto the substrate layer in a pattern-matching way and subsequently pressing the composite board while applying pressure and heat in hydraulic heating press systems. The resin film becomes fluid under the pressure and heat during the pressing process, and polycondensation takes place. The pressing time and temperature determine the degree of cross-linkage of the resins and their surface quality. At the end of the pressing time, the resin has reached the desired degree of cross-linkage and is in a solid phase. The resin surface takes on the desired natural surface due to the surface structure of the embossing tool in this process. Thermosetting resins are used as the coating material, for instance melamine resins, phenolic resins or melamine/urea resins. A structured metal pressing plate, preferably sheet steel, is used as an embossing tool here to structure the surface. The embossing tools are additionally supplied with a coating to improve the resistance to wear and the separation characteristics of the metal surface. Embossing tools in the form of pressing plates or endless belts that were manufactured with the aid of a digital printing technique were preferably used in this manufacturing process, so the decorative papers that are used can likewise be manufactured according to the digital printing process in a true-to-scale and pattern-matching way. A perfectly fitting arrangement of the decorative paper and the embossing structure can consequently be achieved; considerably better results can be achieved than those of the prior art because of that.

Embossing tools in the form of pressing plates or endless belts are manufactured via the corresponding processing of the surface in the prior art and, in fact, by producing a desired surface structure. In the past, the pretreated plate was supplied with a matrix for this purpose, for instance by means of a screen printing process, so that etching of the plate can subsequently be done. The plate is only etched in connection with this in the areas that are not covered by the matrix. Because of the pressing-plate size that is used, very precise processing and, in particular, pattern-matching processing are required here in so far as the production of the surface structure is done in several work steps. All of the areas that are later supposed to form the raised surface structure are covered by the mask over and over again in connected with this, so surface etching only takes place in the areas that can be directed attacked by the etching fluid. The etched-out areas then form the profile valleys of the desired structure; the surfaces are cleaned and the mask is removed at the end of the respective etching process. This procedure can be repeated a number of times; the precision in the screen printing process creates substantial difficulties as a rule for a perfectly fitting application of further masks.

An alternative method involves first applying a photo layer, then subjecting it to illumination and, after the subsequent development of the photo layer, subjecting the plates or endless belts to a rinsing process so that only the parts of the photo layer remain that will form the mask for the etching process later on. The reproducibility of the masks that are created in this way is very difficult and problematic, because the negative or positive that is used to illuminate the light-sensitive layer always has to be exactly arranged in the same position relative to the existing structure. Several illumination and etching steps are therefore required to reproduce complicated three-dimensional structures on the surface of the pressing plate or endless belt, for instance. Even the slightest deviations will lead to substantial displacements of the structures because of the fact that extremely large-format pressing plates are involved. The reproducibility of the application of the mask is therefore associated with substantial difficulties with regard to achieving an accurate copy, especially in the case of the photo method. The difficulties can become worse if a three-dimensional structure has to be obtained via several illumination and etching steps that are required one after the other and the necessity exists here to apply several masks in a row and to carry out an etching process between every instance of a mask application. The production of the pressing plates or endless belts is very complex and cost-intensive because of the precise positioning that is required and the required number of corresponding masks. Furthermore, the results that can be obtained are very strongly dependent upon the processes that are used; complex handling has to be taken into consideration due to the size of the pressing plates or endless belts.

As an alternative, the creation of a mask via the application of wax by means of a print head instead of a screen printing process is known in the prior art. The wax that is applied is chemically resistant to the etching agents that are used here, so etching can be done in the areas where the surface is not covered by the wax. A spray head is used for this purpose that sprays the wax onto the surface and that can be moved along x and y axes to reproduce the required structure. The use of wax to apply a matrix has proven to be disadvantageous, however, because the wax can only be removed from the surface again with difficulty and the required cleaning work is very cost-intensive. The costs that arise because of this and the resolution of a wax matrix have led to further digitalized printing techniques being required. Applying UV lacquer with the aid of a print head on the surface of the embossing tools to be processed, especially pressing plates or endless belts, is known, for example. The special advantage of the digitalized printing technique is that nearly identical masks can be applied over and over again to existing structures, and several etching operations, to bring about a deep structure for instance, can therefore be carried out one after the other in a perfectly fitting way.

A process for applying coatings to surfaces in which a nozzle head is used and the individual nozzles can be controlled via control signals is known from DE 102 24 128 A1, for example. Either the nozzle head can be moved over the surfaces or the surface to be treated is moved vis-a-vis the nozzle head. A UV lacquer that is cured via irradiation with UV light after the application to the surface is preferably used here.

Regardless of the form in which the surfaces of the pressing plates or the endless belts were structured, they will be subjected to several cleaning processes and can additionally be coated with a nickel, brass or copper layer that is subsequently refined with further metallic coatings. The surface gets a desired gloss level and a required surface hardness via the metallic coatings. The gloss level is responsible for the structure that is pressed in connection with this, for instance a composite board, getting different degrees of shading and color reflections after the pressing of the materials to be processed takes place with the aid of the pressing plates or endless belts.

Furthermore, to improve the visual appearance, a suggestion was made to supply partial areas of the surface with different metallic coatings to vary the gloss level. The desired shading effects can be achieved with this measure.

### DETAILED DESCRIPTION

To meet the continually increasing requirements of the furniture industry and the flooring industry, this invention is based on the objective of bringing forth a composite board that has further improved haptics and a further improved visual appearance.

To solve the problem, the invention envisages that a composite board is embossed with at least one structured surface side by a pressing plate or endless belt that has a first gloss level over the full area and that has obtained further, different gloss levels in several selected areas in further work steps; the gloss level can be created via a metal coating, mechanical post-treatment and/or chemical post-treatment.

The different gloss levels of the pressing plate or endless belt are transferred to the structured surface side during the pressing of the composite board. Areas with a higher gloss level and areas with a lower gloss level can consequently be achieved. The possibility exists here to arrange several gloss levels next to one another on the pressing plate so that the pressed composite board will have a surface, due to the shading effects that arise, that not only has a corresponding structure but, moreover, also reflects a visual appearance that comes very close to that of a natural wood material, for instance. As an example, the lower-lying pore areas of a wood pore can be supplied with a lower gloss level, whereas the raised areas can have a higher gloss level. The possibility also exists, of course, to switch the gloss levels with regard to the raised areas and the lower-lying areas. This opportunity for variation only exists in the production of the pressing plates or endless belts, though, so the surface characteristics are exclusively determined by the pressing plates or endless belts that are used. Surface structures of the composite boards that additionally have gloss level differences in lower-lying or raised areas, so that the visual effect of the composite boards is significantly improved once again, are especially appealing here. Moreover, haptics are created that come very close to those of the natural wood products because of the depth of the pores that arise during the pressing process.

It becomes clear from the above-mentioned explanations that the quality of the composite board depends to an increased extent on the quality of the pressing surface or the endless belts, so the production of the pressing plates or endless belts is crucial for the quality of the composite board.

To create the surface structure, there is first a deep etching and then a round etching to bring out the design of the pore structure. After that, mechanical polishing can take place before the surface is cleaned and degreased. The structured surface can additionally be activated before the application of the coatings or other coatings that ensure better adherence, for example a nickel, brass or copper layer, can be applied for better adherence of the metallic layers, especially the chrome layer.

To create a multitude of gloss levels on an embossing tool, the creation of a first, full-surface gloss level that will be achieved via mechanical and/or chemical processing, for instance, is suggested. This first, full-surface gloss level can likewise be created via a metallic coating, though. To achieve further partial gloss levels, mechanical and/or chemical processing can be done after the application of a mask; the possibility likewise exists to create individual gloss levels via a metallic coating. A combination of individual treatment procedures is consequently involved to provide certain areas on a structured surface of the embossing tool, which are reproduced by the wood grain of the surface for instance, with a certain gloss level and other areas with gloss levels deviating from that; in so doing, several different gloss levels can be present on a surface. These gloss levels are created, on the one hand, via a metallic coating and, on the other hand, by mechanical or chemical processing; a digitalized mask is applied between the individual treatment steps merely to process or coat the areas that are supposed to get a deviating gloss level.

To create a multitude of gloss levels, it is possible in principle to use a metallic coating, mechanical post-treatment or chemical post-treatment. They can either be applied individually or in a combination in each case. A metallic coating, for instance by chrome plating the surface a number of times, especially suggests itself for embossing tools that are used in the production of floor coverings or composite boards for the furniture industry.

If a metallic coating is used, it is usually chrome plating; high-gloss chrome plating or matt-finish chrome plating could be involved. It is absolutely conceivable here that other metal coatings could be applied instead of chrome plating.

If a first coating has been applied via chrome plating, it is absolutely necessary for the protective layer (mask) to be applied to be made of a material that is resistant to chromic acid, however, so that the protective layer will not cause problems during the chrome plating or further chrome-plating steps. If the process step for achieving a certain gloss level will be done via polishing or sand-blasting, the protective layer has to correspondingly be a material that is resistant to sand-blasting or polishing so that the surface lying under it has sufficient protection against the post-treatment.

When the structuring measures end, the possibility exists here to first apply a chrome plating with a certain gloss level over the full surface, and a portion of this surface can then be given a deviating gloss level via mechanical or chemical means or possibly a further application of a metallic coating after the application of a matrix; these process steps can be repeated a number of times in individual areas.

A burn-in of the protective layer can be provided as a further intermediate step for better adhesion of the protective layer on the chrome plating that already exists; the protective layer is completely removed after the second treatment is done. To obtain the respective gloss levels, a process step with matt etching, sand-blasting or mechanical polishing can be provided in addition to the metallic coating.

To obtain the different gloss levels, a digital printing technique is used here to apply the protective layer (mask) that ensures a perfectly fitting application of the protective layer, even with multiple repetitions. The application of the protective layer can take place with the following work steps in such a way that they will be applied in an at least partially overlapping way or not in an overlapping way vis-a-vis the areas that have already been finished. It may be necessary, in dependence upon the existing structuring of the surface of the pressing tool, for the partial areas with different gloss levels to be arranged next to one another, but the possibility also exists that an overlap is desired for aesthetic reasons.

A purely metallic coating of the embossing tools is unfavorable for the furniture industry. If a first chrome plating is done with a certain gloss level and further processing steps are subsequently carried out to create different gloss levels, this could lead to a situation in which clearly visible fingerprints are left when the finished composite boards are touched later on. End consumers consider this to be especially annoying, and it is regarded as a visual defect. An approach suggests itself here of only falling back on chemical or mechanical post-treatment after the structuring in the first process steps. A hard chrome plating is absolutely applied in conclusion, though; only the gloss levels are adjusted by the above-mentioned process steps. The surface is less sensitive in later use with this procedure, and this permits an embossing tool to be produced with higher quality, which is in line with the requirements in furniture production.

It is possible with regard to this to do without the first instance of chrome plating and, instead of that, to polish the surface to obtain a certain gloss level. The polishing can be done either in the form of mechanical polishing and/or electropolishing. Mechanical polishing is particularly suitable for obtaining a low level of gloss of the surface. Electropolishing can be used for an especially fine surface and an especially high level of gloss.

After that, a mask can be applied at least once or several times if necessary to supply the other partial areas of the surface structure with further gloss levels deviating from the first gloss levels. A metallic coating can be applied in individual cases here, but mechanical or chemical treatment processes can likewise be used. The special advantage results from the combination of the different treatment procedures that the finest differences in gloss levels can be created and, moreover, cost-effective production is also possible with multiple instances of gloss-level formation.

If mechanical and/or chemical post-treatment is used to adjust the gloss level, there are two possibilities in principle, matting or polishing. In the case of matting, the gloss level of the surface is reduced in general. Etching and sand-blasting are particularly suitable for this. In the case of polishing, the gloss level of the surface is increased. Mechanical polishing or electropolishing are especially suitable for this.

A difference in gloss levels can be provided as an option in connection with this, for instance the raised areas can have a higher gloss level and the lower-lying areas or vice versa. Because of the multiple application of different gloss levels, whether via further coatings or via mechanical or chemical processes, the structured areas of the surface of the pressing plate or the endless belt can be brought out even more clearly than was previously possible. A significant improvement in structuring, accurate in all of the details, is consequently possible.

As an example, a lacquered, real-wood surface can be experienced; the raised surfaces have a certain matt appearance level and the lower-lying wood pore, because of the light reflection, shows a glossy area. The wood-pore structures required here are created with the aid of the perfectly fitting matrix and the known etching technologies.

Because of the use of the digital printing technique, a multiple, perfectly fitting arrangement and an overlap of the respective structure are possible in connection with this, so a variety of gloss levels can be achieved on an existing, structured profile. A variation of the gloss level can be provided in an individual wood pore, for instance. The possibility likewise exists to provide individual wood pores with different gloss levels that are either arranged to be next to one another or that are at fairly large distances from one another. The possibility consequently exists to provide several neighboring wood pores with a deviating gloss level in each case to significantly improve the visual appearance on the whole.

The above-mentioned procedures distinguish themselves by the fact that a structurally conforming overlap exists and no deviation results from the desired structure over the entire surface of the pressing plates or the endless belts. The number of masks is determined by the number of processing steps that are required here; the structuring of the surface is at the center of attention, and a desired adjustment of the gloss level can then be done. The frequency of the masks to be applied and the processing steps is essentially dependent here on the surface structuring, for instance whether a natural reproduction of a wood pore or a stone surface is involved or graphic, artificial structures are to be faithfully reproduced.

The use of the method leads to an embossing tool with a structured surface that fully extends over the entire surface of the embossing tool and that has different gloss levels via the use of metallic coatings and post-treatment processes. A chrome coating is frequently applied in conclusion, because it is especially hard and is best suited for the pressing processes that are to be carried out. The possibility exists without further ado to press other materials, however, that do not have an especially high level of hardness and whose surface is designed to be elastic and soft, so other metallic coatings are also possibilities to be the last covering layer.

The basic advantage of the pressing plates or endless belts that are manufactured in this way is that the composite board gets a structured surface with different gloss levels; the lower-lying areas have a higher gloss level than the raised areas and vice versa. Furthermore, in a special design, the structured surface of the composite boards can have tiered gloss levels in the raised and/or lower-lying area so that the visual appearance can be adapted once again in an improved way to the structure of a wood material.

The special advantage of the embossing tool that is produced is the creation of identical structures, as previously known in nature, with different gloss levels that have an especially pleasing visual appearance and haptics so that the impression arises that grown, natural wood is involved, for instance. Because of the different gloss levels, certain areas, for instance raised areas or lower-lying areas, can be additionally supplied with several deviating gloss levels here, so the structure stands out in a very pithy way and creates a visual effect leading to a material surface that can hardly be distinguished from grown wood, for instance. As an alternative, the possibility exists to correspondingly experience other natural surfaces.

### BRIEF DESCRIPTION OF THE DRAWINGS

The invention will be explained once again below with the aid of the figures.

FIG. 1 shows a composite board;

FIG. 2 shows the existing structure on the surface of the composite board with different gloss levels in an enlarged side view;

FIG. 3 shows a pressing plate for manufacturing the composite board; and

FIG. 4 shows an enlarged view of the pressing plate.

### DETAILED DESCRIPTION OF THE PREFERRED EMBODIMENT

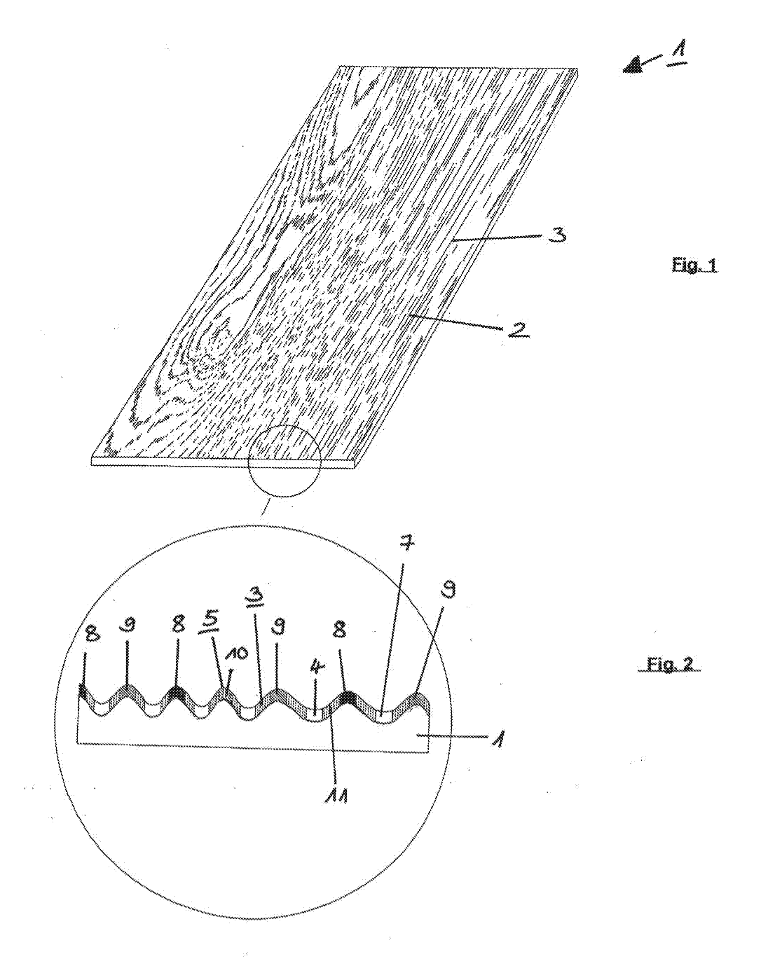

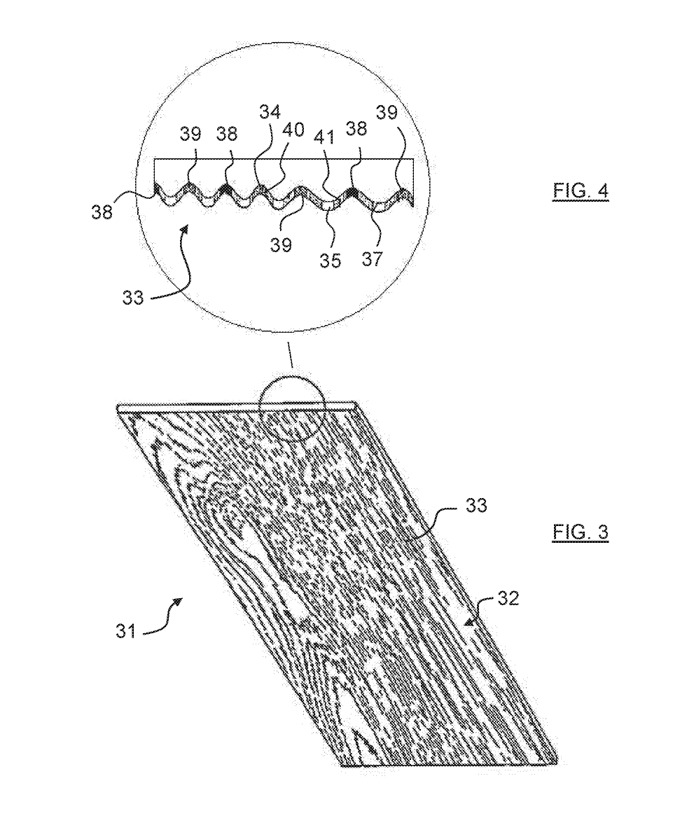

FIG. 1 shows a composite board 1 that is supplied with a structure 3 on its surface 2 in a view in perspective. The example involves a wood pore that is created via pressing with a pressing plate 31 shown in FIG. 3 as an example of an embossing tool. The pressing plate 31 has a negative impression form of the composite board 1 for this purpose, comprises a surface 32, and is supplied with different gloss levels that create different shading effects after the pressing of the surface 2 of the composite board 1. Special haptics and a special visual appearance are consequently achieved in the desired scope on the surface 2 of the composite board 1 because of the gloss levels and the existing imprints.

FIG. 2 shows the composite board 1 with its surface 2 in an enlarged view and FIG. 4 shows the pressing plate 31 with its surface 32 in an enlarged view; the pressing with a pressing plate 31 or an endless belt led to a structure 3 that consists of valleys 4 and peaks 5. The pressing plate 31 has a corresponding structure 33 with valleys 34 and peaks 35. To form the structure 3 of the composite board 1, the pressing plate 31 or endless belt was subjected to several etching processes so that the structure 3 of the composite board 1 with valleys 4 and peaks 5 arises. The composite board 1 shows this structure on its surface 2 after the pressing takes place; different gloss levels exist, in addition, in the areas 7, 8, 9, 10 and 11 of the composite board 1 corresponding to the different gloss levels 37, 38, 39, 40, 41. The example that is shown only discloses one of the possible variations; the original gloss level (first gloss level) of the pressing plate 31 exists in area 7 corresponding to area 37 of the pressing plate 31 because no further post-processing of the pressing plate 31 was done in that area 37. On the other hand, there is a different gloss level in the area of the peaks that arose via subsequent processing of the pressing plate 31 and that was transferred to the surface 2 of the composite board 1 after the embossing took place. The possibility of free choice exists as to which gloss level should be present if there are different gloss levels of the composite board 1 in the peaks 5 and valleys 4. This is illustrated by the fact that some of the peaks 5 have a deviating gloss level in area 9 vis-a-vis area 8. The increasing flanks of the valleys 4 are likewise equipped with different gloss levels, which is indicated by the areas 10 and 11. These gloss levels are also achieved by subjecting the pressing plate 31 that is used to further processing in the area of the flanks, so that the gloss levels of the composite board 1 can be changed vis-a-vis the valleys and peaks. If composite boards are pressed with pressing plates 31 of this type, there is a transfer of the respective gloss level of the pressing plate 31 to the surface of the composite board; a few selected peaks 5 can have a gloss level deviating from the other peaks in the areas 8, 9 because of that, and the flank areas can likewise be equipped with different gloss levels in the areas 10 and 11. If no important gloss-level change has been brought about in the valleys 34 in the pressing plate 31, the possibility absolutely exists without further ado to structure the procedure in such a way that there is a variation of the gloss level in area 7, especially in the valleys 4, whereas, in contrast, the peaks 5 are equipped with the same gloss level in the areas 8, 9. The variation possibilities are very diverse here and are in line with the existing structure in principle, for instance a wood pore, reproduction of stone and other graphic structures.

The pressing plate 31 was made by providing its surface 32 with an original or first gloss level over the full area of the surface 32.

The surface 32 received further, different gloss levels in several selected areas 38, 39, 41, 41 of the surface 32. The gloss levels were created via a mechanical and/or chemical post-treatment, in particular by matting and/or by polishing. The polishing is in particular electropolishing.

The original or first gloss level of the surface 32 of the pressing plate 31 may be achieved by polishing, in particular by electropolishing.

The pressing plate 31 may comprise a hard chrome plating not explicitly shown in the figures and applied to the surface 32 after producing providing the last gloss level.

### LIST OF REFERENCE NUMERALS

1 Composite board
2 Surface
3 Structure
4 Valley
5 Peak
7 Area
8 Area
9 Area
10 Area
11 Area
31 Embossing tool/pressing plate
32 Surface
33 Structure
34 Valley
35 Peak
37 Area
38 Area
39 Area
40 Area
41 Area

1. An embossing tool, comprising
a pressing plate or endless belt which comprises a structured surface, a first gloss level over the full area of the structured surface, and further, different gloss levels in several selected areas of the structured surface, the gloss levels having been created by mechanical post-treatment and/or chemical post-treatment.

2. The embossing tool of claim 1, the gloss levels being arranged to be at least partially next to one another or the gloss levels of the structured surface running at least partially at a distance from one another.

3. The embossing tool of claim 1, the different gloss levels of the structured surface are achieved by matting and/or polishing as the mechanical and/or chemical post-treatment.

4. The embossing tool of claim 3, the matting being etching and/or sandblasting.

5. The embossing tool of claim 3, the polishing being mechanical polishing and/or electropolishing.

6. The embossing tool of claim 1, wherein the structured surface is comprised of tiered gloss levels in a raised and/or lower-lying area.

7. The embossing tool of claim 1, comprising a hard chrome plating applied to the structured surface after the production of the last gloss level.

8. The embossing tool of claim 1, the structured surface having different gloss levels, lower-lying areas of the structured surface having a higher gloss level than the raised areas or vice versa.

9. A method for producing the embossing tool as claimed in claim 1, wherein the structured surface is provided with a first gloss level over the full area and receives further, different gloss levels in several selected areas in further work steps, wherein the gloss levels are created via a mechanical post-treatment and/or chemical post-treatment.

10. The method as claimed in claim 9, wherein a protective layer defined as a mask is applied at least partially by means of a digital printing technique to the surface of the embossing tool to establish the selected areas, wherein the protective layer is arranged at least partially in an overlapping way or not in an overlapping way in subsequent work steps to the selected areas that have already been finished, and wherein the gloss levels are arranged to be at least partially next to one another or that the gloss levels of the surface at least partially run at a distance from one another, and wherein the protective layer is burned into the surface and/or a coating.

11. The method as claimed in claim 10, wherein a material that is resistant to etching, sand-blasting and/or polishing is used for the protective layer.

12. The method of claim 9, wherein the gloss levels of the surface of the embossing tool are achieved by matting and/or by polishing as the mechanical and/or chemical post-treatment.

13. The method of claim 12, wherein the matting is etching and/or sandblasting.

14. The method of claim 12, wherein the polishing is mechanical polishing and/or electropolishing.

15. The method of claim 9, the first gloss level being achieved by polishing.

16. The method of claim 9, the first gloss level being achieved by mechanical polishing and/or electropolishing.

17. The embossing tool of claim 1, the first gloss level being achieved by polishing.

18. The embossing tool of claim 1, the first gloss level being achieved by mechanical polishing and/or electropolishing.
